(19) United States
(12) Patent Application Publication
(10) Pub. No.: US 2001/0032956 A1
(43) Pub. Date: Oct. 25, 2001

(54) Valve including seal assembly retainer

(76) Inventor: Aleem A. Khokhar, Greenfield, WI (US)

Correspondence Address: MICHAEL BEST & FRIEDRICH, LLP, 100 E WISCONSIN AVENUE, MILWAUKEE, WI, 53202, US

(21) Appl. No.: 09/779,891

(22) Filed: Feb. 8, 2001

Related U.S. Application Data
(60) Provisional application No. 60/181,442, filed on Feb. 10, 2000.

(51) Int. Cl. F16K 1/22; F16K 5/00

(52) U.S. Cl. 251/306; 251/305; 251/314

(57) ABSTRACT

A valve and method of assembling a valve, the valve being dead-end capable. The valve includes a valve body, a valve member, a seal and a retainer to prevent axial movement of the seal relative to the valve body. In one construction, the valve body defines a first groove extending about a portion of the circumference and an opening communicating with the first groove. The seal has an outer surface engageable with the valve body and defining a second groove. When the seal is positioned in the bore, the second groove is substantially co-extensive with at least a portion of the first groove to define a groove pocket. To prevent axial movement of the seal relative to the valve body, the retainer has a portion positionable in the first groove and an other portion positionable in the second groove. The retainer enters the groove pocket through the opening. Preferably, the valve further comprises a closing member for closing the opening to prevent the retainer from being removed from the groove pocket. In another construction, the valve body defines a groove on an upstream portion, and the seal includes a projection engageable in the groove to restrain axial movement of the seal relative to the valve body.

The present application claims the benefit of U.S. Provisional Application Ser. No. 60/181,442, filed Feb. 10, 2000.

### FIELD OF THE INVENTION

The present invention relates to valves and, more particularly, to a seal assembly retainer for a valve which is dead-end capable.

### BACKGROUND OF THE INVENTION

A typical butterfly valve includes a valve body defining a bore, a disc-shaped valve member mounted in the bore and pivotable about an axis extending transverse to the bore, and an annular seal element extending around the axis inside the bore. Such a valve is typically used between two pipe flanges. The valve is positioned between the opposing pipe flanges which are then drawn together by bolts to axially restrain the valve and the seal element. The seal element provides a seal between the valve body and the valve member when the valve member is in a closed position and between the valve body and the pipe flanges.

Only specially-designed butterfly valves may be used at the end of a single pipe for shut-off, commonly referred to as dead-end service, with the discharge or downstream side of the valve being exposed to a lower pressure, such as atmosphere. U.S. Pat. No. 3,656,714 describes such a valve used in this type of shut-off service. The valve includes a valve seat retaining means to prevent the valve seat from axially shifting relative to the valve body. The valve seat retaining means includes a spring-biased annular sector which extends into grooves formed in the valve seat and in the valve body to prevent axial movement of the valve seat relative to the valve body.

U.S. Pat. No. 4,552,332 discloses another such valve used for dead-end service. The sealing element of the valve includes a rigid support ring and a sealing ring which partially embeds the support ring. The valve body includes at least one detaining projection extending radially inwardly into the valve passage. An exposed portion of the support ring abuts against this detaining projection to detain the support ring and the entire sealing element in position against axial displacement.

### SUMMARY OF THE INVENTION

One problem with butterfly valves which are generally designed to be used between two pipes is that these valves are unsuitable for use in shut-off or dead-end service in which the downstream pipe is removed from the valve so that the valve is at the end of a single pipe in shut-off or dead-end service. Because the annular seal element is not restrained on the discharge or downstream side of the valve (from which the pipe was removed), the seal element may tend to shift axially within the valve body due to the force applied by the still-connected flange to the seal element and due to the fluid pressure. This causes the seal element to move out of proper sealing engagement with the valve member, resulting in leakage in the area between the valve member, along an axis extending transverse to the bore, and the seal element.

Another problem with typical butterfly valves is that, when these valves are used in dead-end service, the axial forces are resisted by the stems supporting the valve member. Such forces can damage the annular seal element, requiring repair of the valve.

Yet another problem with typical butterfly valves is that these valves cannot be easily converted to dead-end use.

One problem with the valve described in U.S. Pat. No. 3,656,714 is that an additional component, an expander mandrel member, is required to assemble the valve. The mandrel is connected to the forward portion of the valve seat and pushed through the valve bore to depress the annular sectors so that the valve seat may be positioned.

One problem with the valve described in U.S. Pat. No. 4,552,332 is that the valve body projection engages the downstream portion of the support ring of the sealing element. As a result, the force applied by the upstream pipe flange to the sealing element is transmitted through a majority of the sealing element (in an axial direction) and through the valve stems to the downstream projection on the valve body. This increases the likelihood of damage to the sealing element and of the resulting leakage of the valve.

To alleviate the problems with the above-described valves, the present invention provides a valve and a method of assembling the valve. The invention provides a valve which may be used between two pipes or which may be used at the end of a single pipe in shut-off or dead-end service. The invention also provides a valve which, when used in dead-end service, prevents axial displacement of the seal relative to the valve body so that a sealing engagement is maintained between the seal and the valve member and between the seal and the pipe flange. In addition, the invention provides a valve which does not require any special tools for assembly. Further, the invention provides a valve which is quickly and easily assembled and disassembled.

More particularly, the present invention provides a valve including a valve body, a valve member, a seal and a retainer to prevent movement of the seal relative to the valve body. The valve body defines a groove, and a portion of the retainer is positionable in the groove to prevent movement of the seal relative to the body.

In one embodiment, the valve body defines a first groove extending about a portion of the circumference of the valve body. The valve body also defines an opening in the outer surface, the opening communicating with the first groove. The valve member is pivotably supportable in the bore and has a circumferential sealing surface. The seal is positionable in the bore and provides a seal between the valve body and the valve member and between the valve body and the pipe flange. The seal has a seal surface which is engageable with the sealing surface of the valve member when the valve member is in the closed position. The seal has an outer surface engageable with the valve body and preferably defining a second groove. The second groove is preferably substantially co-extensive with at least a portion of the first groove to define a groove pocket when the seal is positioned in the bore.

To prevent axial movement of the seal relative to the valve body, the retainer preferably has a portion positionable in the first groove and another portion positionable in the second groove. Preferably, the retainer enters the groove pocket through the opening.

Preferably, the valve further includes a closing member for closing the opening to prevent the retainer from being removed from the groove pocket. Also, the closing member may be removable from the opening to allow removal of the retainer from the groove pocket.

Preferably, the seal defines a plurality of second grooves, each second groove being circumferentially spaced apart from one another and being co-extensive with a portion of the first groove. The first groove and the second grooves preferably define a corresponding plurality of groove pockets. Preferably, the valve body defines a plurality of openings, each opening communicating with a corresponding groove pocket.

The retainer preferably includes a plurality of spherical retainer members positionable in the groove pocket. Preferably, a retainer, such as the plurality of retainer members, is positioned in each groove pocket through the corresponding opening.

Preferably, the seal includes a seal member providing the seal surface and a support member engageable with the seal member to prevent axial movement of the seal member relative to the support member. The support member is engageable with the valve body and preferably defines the second groove. Preferably, the retainer prevents axial movement of the support member relative to the valve body.

In one construction, the valve is connectable to a pipe flange, and the valve body preferably includes a connecting portion for connecting the valve to the pipe flange. A portion of the seal surface is engageable with the pipe flange to provide a seal between the valve and the pipe flange.

In another construction, the valve is connectable between a first pipe flange and a second pipe flange. A portion of the seal is engageable with the first pipe flange to provide a seal between the first pipe flange and the valve, and another portion of the seal is engageable with the second pipe flange to provide a seal between the second pipe flange and the valve.

In another embodiment, the retainer is integrally formed with the seal. The retainer on the seal is positionable in the groove in the valve body to prevent movement of the seal relative to the valve body.

Also, the present invention provides a method for assembling a valve. The method includes the acts of positioning the seal assembly in the valve bore, supporting the valve member in the valve bore, and positioning the retainer so that a portion of the retainer is positioned in the groove to prevent movement of the seal relative to the valve body.

In one embodiment, the method may include the act of positioning the seal in a valve bore so that the seal engages the valve body and so that the second groove defined by the seal is substantially co-extensive with at least a portion of the first groove. The method may also include the acts of supporting the valve member in the bore and positioning the retainer in the groove pocket through the opening.

Preferably, the method further includes the act of closing the opening by positioning the closing member in the opening. Further, the method may include the acts of removing the closing member from the opening, removing the retainer from the groove pocket, removing the valve member from the valve body, and removing the seal from the valve body. In addition, the method may further include the act of engaging the support member with the seal member to prevent axial movement of the seal member relative to the support member.

One advantage of the present invention is that the valve is rated for and may be used with a single pipe in shut-off or dead-end service. When the valve is used in dead-end service, a seal is maintained between the valve member and the valve body and between the valve and the pipe.

Another advantage of the present invention is that, when the valve is used in dead-end service, because the seal is axially restrained, the seal does not move relative to the valve body, due to the forces applied by the pipe flange, and thereby maintains its sealing arrangement. Also, the valve member and stems are not required to withstand the axial forces applied by the pipe flange. For these reasons, the seal and the valve member are less likely to be damaged, and the valve is less likely to require repair.

Yet another advantage of the present invention is that the valve is dead-end capable without additional components and may be easily placed in dead-end service in the field.

A further advantage of the present invention is that the valve may be quickly and easily assembled and disassembled without additional tools.

Another advantage of the present invention is that the seal is retained on the upstream side of the valve body so that the forces applied by the pipe flange are not transmitted through a majority of the seal (in the axial direction) and are not transmitted through the valve stems.

Other features and advantages of the invention will become apparent to those skilled in the art upon review of the following detailed description, claims and drawings.

### DESCRIPTION OF THE DRAWINGS

FIG. 1 is a front cross-sectional view of a valve embodying the invention.

FIG. 2 is a partial cross-sectional view taken generally along line 2-2 in FIG. 1.

FIG. 3 is a view similar to that shown in FIG. 1 and illustrating the valve in an assembled condition.

FIG. 4 is a partial cross-sectional view taken generally along line 4-4 in FIG. 3.

FIG. 5 is a partial cross-sectional view taken generally along line 5-5 in FIG. 4.

FIG. 6 is a partial cross-sectional side view of another embodiment of a valve embodying the invention.

FIG. 7 is an expanded partial cross-sectional view of a portion of the valve illustrated in FIG. 6.

FIG. 8 is an expanded partial cross-sectional view of a portion of the valve illustrated in FIG. 6.

Before one embodiment of the invention is explained in detail, it is to be understood that the invention is not limited in its application to the details of the construction and the arrangements of the components set forth in the following description or illustrated in the drawings. The invention is capable of other embodiments and of being practiced or carried out in various ways. Also, it is understood that the phraseology and terminology used herein is for the purpose of description and should not be regarded as limiting.

### DETAILED DESCRIPTION OF THE PREFERRED EMBODIMENT

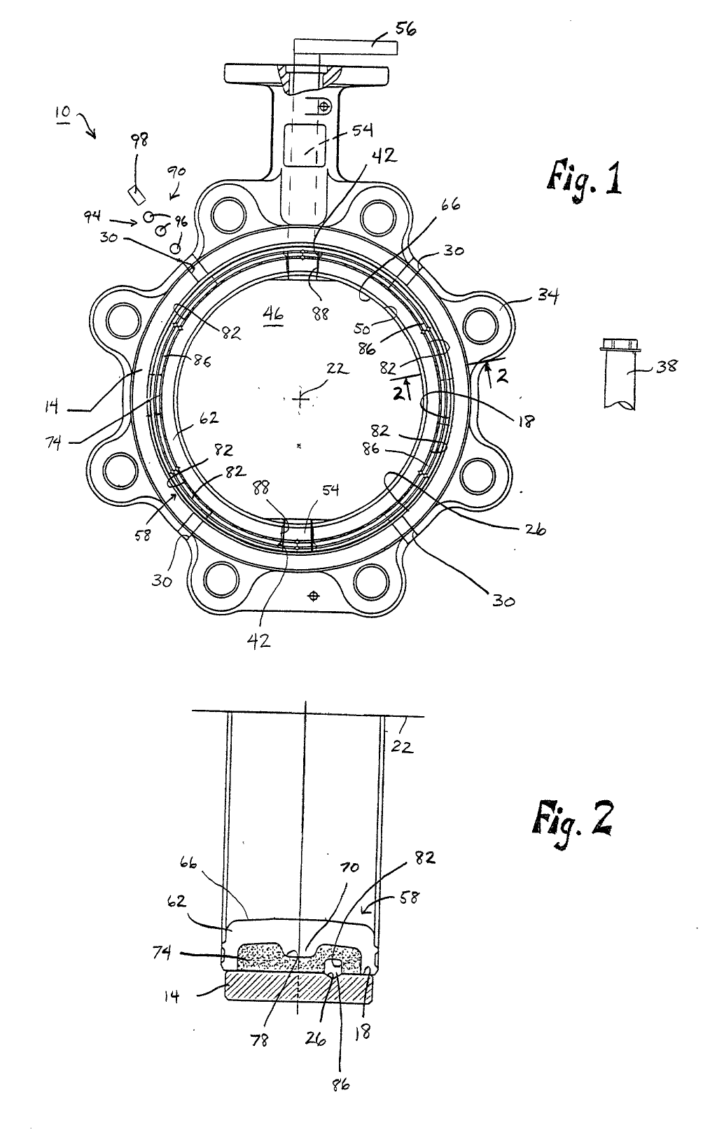

A valve 10 embodying the invention is illustrated in FIGS. 1-2 in a partially disassembled condition. The valve 10 is capable of being used in shut-off or dead-end service. It should be understood that “dead-end service” may refer to use of the valve 10 at the end-of-the-line of a system. However, “dead-end service” typically refers to use of the valve 10 between two components in the system, one of which may be removed, for example, for servicing or replacement. During such conditions, the valve 10 has the discharge or downstream side exposed to a lower pressure and is thus in “dead-end service”.

As shown in FIGS. 1-2, the valve 10 includes a valve body 14 defining a valve bore 18 having a bore axis 22 and a circumference. A first groove 26 is defined in the inner surface of the valve body 14. In the illustrated construction, the first groove 26 extends substantially about the circumference of the bore 18 and is generally V-shaped in cross-section.

At least one and, preferably, a plurality of insertion ports or openings 30 are defined in the valve body 14 and extend through the outer surface of the valve body 14. In the illustrated construction, four openings 30 are circumferentially spaced apart and communicate with the first groove 26.

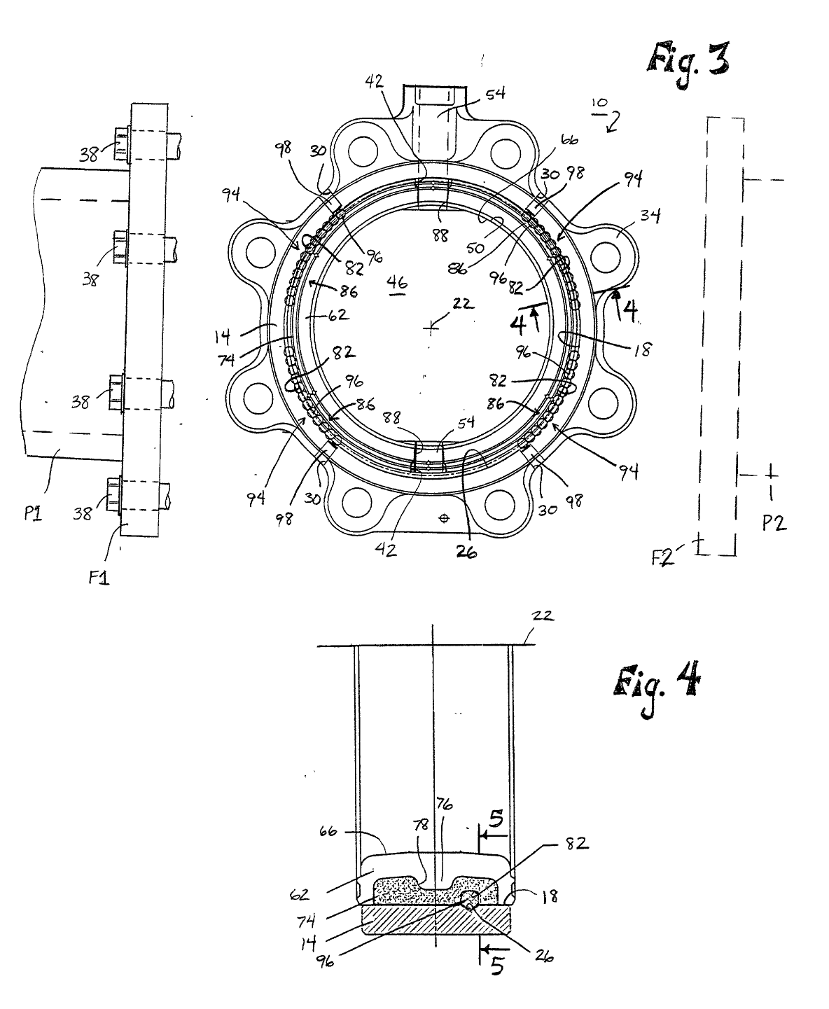

As shown in FIGS. 1 and 3, the valve body 14 also includes a connecting portion 34. The valve 10, through the connecting portion 34 and fasteners 38, is connectable to a single pipe, in dead-end service, or between two pipes. The valve body 14 also defines valve body stem passages 42. The stem passages 42 are axially spaced from the first groove 26.

The valve 10 also includes a valve member 46 supportable in the bore 18. The valve member 46 is disc-shaped and includes an outer circumferential sealing surface 50. The valve member 46 also includes stems 54 which are supported in the stem passages 42. The valve member 46 is supported for pivotable movement about a pivot axis defined by the stems 42 and generally transverse to the bore axis 22. The valve member 46 is pivotable between a closed position (shown in FIGS. 1 and 3), in which flow through the valve 10 is substantially prevented, and an open position (not shown), in which fluid may flow through the valve 10. An actuator 56 extends from one stem 54 and is engageable by an operator to move the valve member 46 between the closed position and the open position.

As best shown in FIGS. 2 and 4, the valve 10 also includes a seal assembly 58 positionable in the bore 18. The seal assembly 58 provides a seal between the valve body 14 and the valve member 46. The seal assembly 58 also provides a seal between the valve body 14 and the single pipe (in one construction) or two pipes (in another construction) to which the valve 10 is connected.

The seal assembly 58 includes a sleeve or seal member 62 having a seal surface 66 engageable with the sealing surface 50 of the valve member 46 when the valve member 46 is pivoted to the closed position to prevent flow through the valve 10. A ridge 70 is defined on the opposite surface of the seal member 62. The seal surface 66 has axially-facing end portions. The seal member 62 is preferably made of a resilient material.

The seal assembly 58 also includes a backing or support member 74. The support member 74 is engageable with the seal member 62 to prevent movement of the seal member 62 relative to the support member 74 along the bore axis 22. To provide this engagement, the support member 74 defines a recess 78 which is complementary to the ridge 70 defined by the seal member 62, and the axial ends of the seal member 62 surround the axial ends of the support member 74.

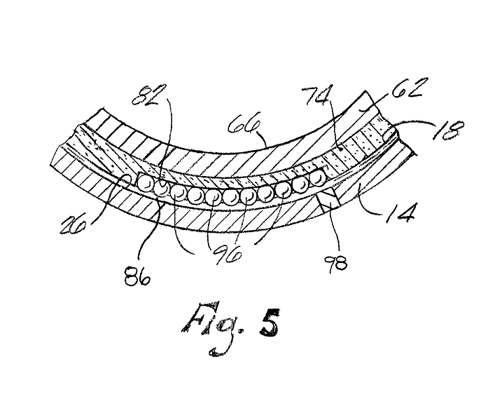

As best shown in FIGS. 2-5, the support member 74 defines at least one and, preferably, a plurality of second grooves 82. In the illustrated construction, the support member 74 defines four second grooves 82 each having a generally U-shaped cross-section. The second grooves 82 are spaced apart about the circumference of the support member 74. When the seal assembly 58 is positioned in the bore 18, the support member 74 engages the inner surface of the valve body 14, and each second groove 82 is substantially co-extensive with a portion of the first groove 26. The first groove 26 and the second grooves 82 define corresponding groove pockets 86 (one shown in FIG. 5). In the illustrated construction (see FIG. 3), four groove pockets 86 are defined, and an opening 30 communicates with each groove pocket 86. Preferably, each groove pocket 86 extends 45° about the circumference of the valve bore 18.

As shown in FIGS. 1 and 3, seal assembly stem passages 88 are defined through the seal member 62 and through the support member 74. The stem passages 88 are aligned with the valve body stem passages 42 when the seal assembly 58 is positioned in the valve bore 18. The portions of the seal member 62 about the periphery of the stem passages 88 provide a seal between the stems 54 and the seal assembly 58.

It should also be understood that, in other construction (not shown), the seal assembly 58 may include only a single member providing the characteristics of both the seal member 62 and the support member 74. Further, in yet other constructions (not shown), the seal member 62 and the support member 74 may be integrally formed.

The valve 10 also includes (see FIGS. 3-5) a retainer assembly 90 positionable to prevent movement of the seal assembly 58 relative to the valve body 14 along the bore axis 22. The retainer assembly 90 includes a retainer 94 for each groove pocket 86. The retainer has a portion positionable in the first groove 26 and an other portion positionable in the second groove 82. The retainer 94 is positionable in the groove pocket 86 through the corresponding opening 30. Preferably, each retainer 94 includes a plurality of retainer members 96, such as spherical balls, which are positionable in the corresponding groove pocket 86. The retainer members 96 are inserted into each groove pocket 86 through the corresponding opening 30.

The retainer assembly 90 also includes a cap or closing member 98 for each opening 30. Each closing member 98 is positioned in the corresponding opening 30 to prevent removal of the retainer members 96 from the groove pocket 86. The closing members 98 are not typically removable from the openings 30 without damaging the closing members 98.

It should be understood that, in other constructions (not shown), the retainer 94 may have a different construction and shape. For example, the retainer members 96 may not be spherical but may correspond to the shape of the first groove 26 and the second groove 82 (not shown). Also, only one retainer (not shown) may be provided for each groove pocket 86. In such a construction, the retainer (not shown) may be elongate and flexible, to enter the groove pocket 86 through the opening 30, but radially stiff, to prevent axial movement of the seal assembly 58 relative to the valve body 14.

Further, it should be understood that, in other constructions (not shown), the closing members 98 may be removable from the openings 30 to allow removal of the retainer members 94 from the groove pockets 86 and to allow disassembly of the valve 10. Also, in yet other constructions (not shown), the closing member may be integrally formed with the retainer to prevent removal of the retainer from the groove pocket 86.

As shown in FIG. 3, in one construction, the valve 10 is connectable (when pivoted 90° from the orientation shown in FIG. 3), through the connecting portion 34 and fasteners 38, to the flange portion F1 of a first pipe P1 in dead-end service. In another construction, the valve 10 (when pivoted 90° from the orientation shown in FIG. 3) is connected between the first pipe P1 and a second pipe P2 (shown in phantom) having a flange portion F2.

To assemble the valve 10 (see FIG. 2), the seal member 62 and the support member 74 are engaged. The seal assembly 58 is then positioned in the valve bore 18 so that each second groove 82 is co-extensive with the corresponding portion of the first groove 26 to define the corresponding groove pocket 86. As shown in FIG. 1, the valve member 46 is positioned in the bore 18 so that the stems 54 extend through the seal assembly stem passages 88 and are supported in the valve body stem passages 42.

As shown in FIGS. 3-5, the retainer members 96 are positioned in each groove pocket 86 through the corresponding opening 30. Each closing member 98 is then positioned in the corresponding opening 30 to prevent removal of the retainer members 96 from the corresponding groove pocket 86.

The valve 10 may be shipped and handled in this assembled condition. The assembled valve 10 may also be connected either to a single pipe P1, if used in dead-end service, or between two pipes P1 and P2. During use between two pipes P1 and P2, the downstream pipe may be removed, for example, for servicing or replacing a downstream component in the system, so that the valve 10 is temporarily in dead-end service.

To disassemble the valve 10, the assembly process is reversed. The valve 10 is removed from the pipe P1 or from between the pipes P1 and P2. The valve member 46 is then removed from the valve body 14, and the seal assembly 58 is removed from the valve body 14. If the closing members 98 are not removable, the seal assembly 58 is cut apart and removed from the valve body 14. A new seal assembly (not shown) and a new retainer assembly (not shown) is then provided for use in the valve 10.

If the closing members 98 are removable, each closing member 98 is removed from the corresponding opening 30, and the retainer members 96 are removed from the corresponding groove pocket 86. The valve member 46 is then removed from the valve body 14, and the seal assembly 58 is removed from the valve body 14.

It should be understood that, in other constructions (not shown), the first groove 26 and the second grooves 82 may have different cross-sectional shapes than those described above. Further, in yet other constructions (not shown), the valve body 14 and the support member 74 may define a different groove configuration. For example, the first groove 26 may extend only about a portion of the circumference of the bore 18 (not shown), or a plurality of circumferentially spaced apart first grooves 26 may be defined (not shown).

Also, it should be understood that, in other constructions (not shown), the support member 74 may define a single second groove extending substantially about the circumference of the support member 74. In addition, the support member 74 may define fewer or more than four second grooves 82 to provide a corresponding fewer or more groove pockets 86 (not shown). In such a construction, the valve member would define a corresponding number of openings 30.

FIGS. 6-8 illustrate another embodiment of a valve 10′ embodying the invention. Common elements are identified with the same reference number“′”.

The valve 10′ is capable of being used in dead-end service. As shown in FIG. 6, the valve 10′ includes a valve body 14′ defining a valve bore 18′ having a bore axis 22′ and a circumference. A groove 102 is defined in the inner surface of the valve body 14′ adjacent the upstream axial end of the valve body 14′.

The valve body 14′ also includes a connecting portion (not shown), and the valve 10′, through the connecting portion and fasteners (not shown), is connectable to a single pipe, in dead-end service, or between two pipes. The valve body 14′ also defines valve body stem passages 42′ spaced axially downstream from the groove 102.

The valve 10′ also includes a valve member (not shown but similar to the valve member 46) supportable in the bore 18′. The valve member is generally disc-shaped and includes an outer circumferential sealing surface (not shown). The valve member also includes stems (not shown) which are supported in the stem passages 42′. The valve member is supported for pivotable movement about a pivot axis defined by the stems and generally transverse to the bore axis 22′. The valve member is pivotable between a closed position, in which flow through the valve 10′ is substantially prevented, and an open position, in which fluid may flow through the valve 10′. An actuator (not shown) extends from one stem and is engageable by an operator to move the valve member between the closed position and the open position.

The valve 10′ also includes a valve seal assembly 58′ positionable in the bore 18′. The seal assembly 58′ provides a seal between the valve body 14′ and the valve member. The seal assembly 58′ also provides a seal between the valve body 14′ and the single pipe (in some constructions, not shown) or two pipes (in other constructions, not shown) to which the valve 10′ is connected.

The seal assembly 58′ includes a sleeve or seal member 62′ having a seal surface 66′ engageable with the sealing surface of the valve member when the valve member is pivoted to the closed position to prevent flow through the valve 10′. A ridge 70′ is defined on the opposite surface of the seal member 62′. The seal surface 66′ has axially-facing end portions. An annular rib or projection 106 is defined on the upstream axial end of the seal member 62′. The seal member 62′ is preferably made of a resilient material.

The seal assembly 58′ also includes a backing or support member 74′. The support member 74′ is engageable with the seal member 62′ to prevent relative movement of the seal member 62′ and the support member 74′. To provide this engagement, the support member 74′ defines a recess 78′ which is complementary to the ridge 70′ defined by the seal member 62′, and the axial ends of the seal member 62′ surround the axial ends of the support member 74′.

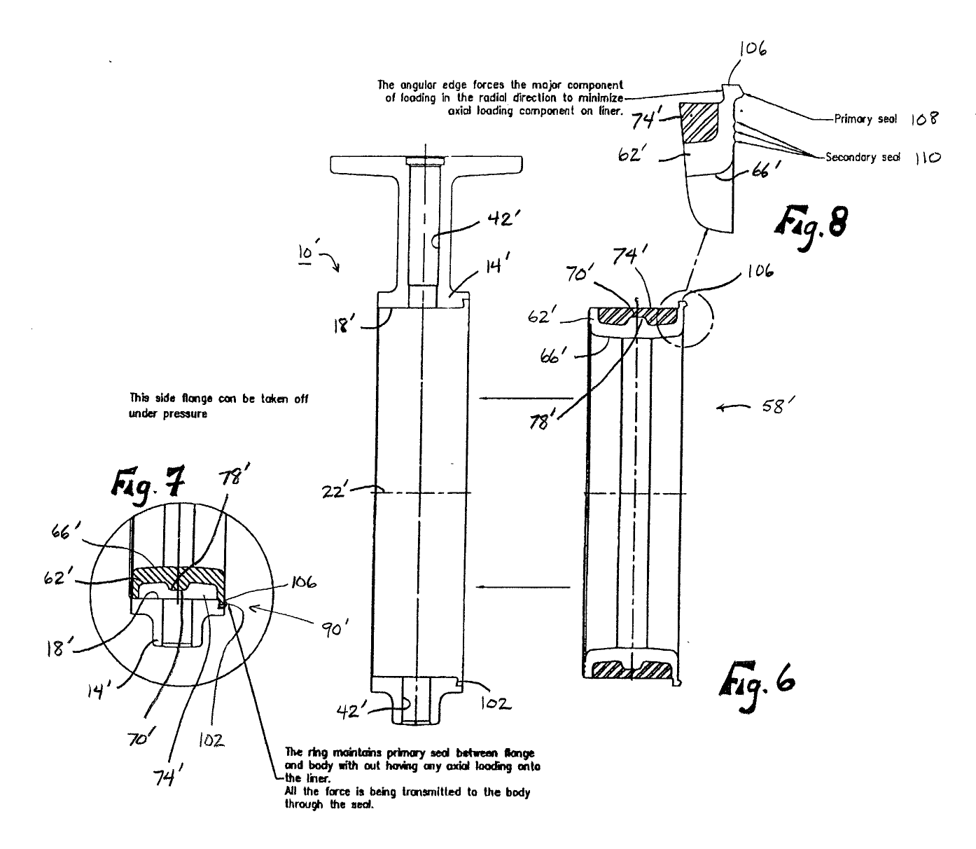

As shown in FIG. 7, when the seal assembly 58′ is positioned in the bore 18′, the support member 74′ engages the inner surface of the valve body 14′, and the annular projection 106 engages the groove 102. The annular projection 106 and the groove 102 thus provide a retainer assembly 90′ to prevent axial movement of the seal assembly 58′ relative to the valve body 14′.

A pipe (not shown) having a flange is connected to the upstream axial end of the valve 10′ (including the annular projection 106 and the groove 102). The flange portion of the pipe engages (see FIG. 8) a portion 108 of the annular projection 106 to provide a primary seal between the flange and the valve 10′ without having any axial loading transferred to the remainder of the seal assembly 58′. Ridges 110 on the axially-facing end portion of the seal surface 66′ provide a secondary seal between the flange and the valve 10′. Similar ridges (not shown in detail) are formed on the downstream axially-facing end portion of the seal surface 66′ to provide a seal between the flange of the downstream pipe (if provided) and the valve 10′.

As shown in FIGS. 6-8, the angled edges of the annular projection 106 of the groove 102 (relative to the axis 22′) direct a major component of the force applied by the pipe flange in a radial direction, minimizing the axial load on the seal assembly 58′. Also, the annular projection 106 maintains the primary seal between the valve body 14′ and the pipe flange without significant axial loading on the remainder of the seal assembly 58′. The force applied by the pipe flange is transmitted through the annular projection 106 to the upstream end of the valve body 14′.

Various features of the invention are set forth in the following claims.

What is claimed is:

1. A valve comprising:
a valve body having an outer surface and defining a bore having a bore axis and a circumference, said valve body defining a groove extending about a portion of said circumference;
a valve member supportable in said bore for pivotable movement about a pivot axis substantially transverse to said bore axis, said valve member being movable between a closed position, in which flow through said valve is substantially prevented, and an open position, said valve member having a circumferential sealing surface;
a seal positionable in said bore and for providing a seal between said valve body and said valve member, said seal having a seal surface engageable with said sealing surface of said valve member when said valve member is in said closed position, said seal having an outer surface engageable with said valve body; and
a retainer having a portion positionable in said groove to prevent movement of said seal relative to said valve body along said bore axis.

2. The valve as set forth in claim 1 wherein said valve body defines an opening in said outer surface, said opening communicating with said first-mentioned groove, wherein said seal defines a second groove in said outer surface, said second groove being substantially co-extensive with at least a portion of said first-mentioned groove to define a groove pocket when said seal is positioned in said bore, wherein said retainer has an other portion positionable in said second groove, and wherein said retainer enters said groove pocket through said opening.

3. The valve as set forth in claim 2 and further comprising a closing member for closing said opening to prevent said retainer from being removed from said groove pocket.

4. The valve as set forth in claim 2 wherein said retainer includes a plurality of spherical retainer members positionable in said groove pocket.

5. The valve as set forth in claim 2 wherein said seal defines a plurality of second grooves, each of said plurality of second grooves being circumferentially spaced apart from others of said plurality of second grooves and being co-extensive with a portion of said first groove to define a plurality of groove pockets, wherein said valve body defines a plurality of openings, one of said plurality of openings communicating with a respective one of said plurality of groove pockets, and wherein said valve further comprises a plurality of retainers, one of said plurality of retainers being positioned in a respective one of said plurality of groove pockets through a corresponding one of said plurality of openings.

6. The valve as set forth in claim 5 and further comprising a plurality of closing members, each of said plurality of closing members being positionable in a respective one of said plurality of openings to prevent removal from a corresponding one of said plurality of retainers from said respective one of said plurality of groove pockets.

7. The valve as set forth in claim 5 wherein each of said plurality of retainers includes a plurality of retainer members positioned in said respective one of said plurality of groove pockets.

8. The valve as set forth in claim 2 wherein said seal includes
a seal member providing said seal surface engageable with the sealing surface of said valve member, and
a support member engageable with said seal member to prevent movement of said seal member relative to said support member along said bore axis, said support member being engageable with said valve body and defining said second groove,
wherein said retainer member prevents movement of said support member relative to said valve body along said bore axis.

9. The valve as set forth in claim 2 wherein said valve is connectable to a pipe in dead-end service, and wherein said valve body includes a connecting portion for connecting said valve to the pipe.

10. The valve as set forth in claim 9 wherein a portion of said seal surface is engageable with the pipe to provide a seal between said valve and the pipe.

11. The valve as set forth in claim 2 wherein said valve is connectable between a first pipe and a second pipe, wherein a portion of the seal is engageable with the first pipe to provide a seal between the first pipe and the valve, wherein an other portion of the seal is engageable with the second pipe to provide a seal between the second pipe and the valve, and wherein said valve body includes a connecting portion for connecting said valve to said first pipe and to said second pipe.

12. The valve as set forth in claim 1 wherein said retainer is integrally formed with said seal.

13. A valve comprising:
a valve body having an outer surface and defining a bore having a bore axis and a circumference, said valve body defining a groove extending about a portion of said circumference;
a valve member supportable in said bore for pivotable movement about a pivot axis substantially transverse to said bore axis, said valve member being pivotable between a closed position, in which flow through said valve is substantially prevented, and an open position, said valve member having a circumferential sealing surface;
a seal assembly positionable in said bore and for providing a seal between said valve body and said valve member, said seal assembly including
a seal member having a seal surface engageable with said sealing surface of said valve member when said valve member is in said closed position, and
a support member being engageable with said seal member to prevent movement of said seal member relative to said support member along said bore axis, said support member having an outer surface engageable with said valve body; and
a retainer assembly for preventing movement of said seal assembly relative to said valve body along said bore axis, said retainer assembly including a retainer having a portion positionable in said groove to prevent axial movement of said seal assembly.

14. The valve as set forth in claim 13 wherein said valve body defines an opening in said outer surface, said opening communicating with said first-mentioned groove, wherein said seal defines a second groove in said outer surface, said second groove being substantially co-extensive with at least a portion of said first-mentioned groove to define a groove pocket when said seal is positioned in said bore, wherein said retainer has an other portion positionable in said second groove, wherein said retainer enters said groove pocket through said opening, and wherein said retainer assembly further includes a closing member positionable in said opening to prevent removal of said retainer member from said groove pocket.

15. The valve as set forth in claim 14 wherein said retainer includes a plurality of retainer members positionable in said groove pocket.

16. The valve as set forth in claim 15 wherein said first groove extends substantially about said circumference of said bore, wherein said support member defines a plurality of second grooves, each of said plurality of second grooves being circumferentially spaced apart from others of said plurality of second grooves and being co-extensive with a portion of said first groove, said first groove and said plurality of second grooves respectively defining a plurality of groove pockets, wherein said valve body defines a plurality of openings, one of said plurality of openings communicating with one of said plurality of groove pockets, and wherein said retainer assembly includes a plurality of retainers, one of said plurality of retainers being positioned in one of said plurality of groove pockets through a corresponding one of said plurality of openings.

17. The valve as set forth in claim 13 wherein said retainer member is integrally formed with one of said seal member and said support member.

18. The valve as set forth in claim 17 wherein said retainer member is integrally formed with said seal member.

19. A valve comprising:
a valve body having an outer surface and defining a bore having a bore axis and a circumference, said valve body defining a first groove extending about a portion of said circumference, said valve body defining an opening in said outer surface, said opening communicating with said first groove;
a valve member supportable in said bore for pivotable movement about a pivot axis substantially transverse to said bore axis, said valve member being movable between a closed position, in which flow through said valve is substantially prevented, and an open position, said valve member having a circumferential sealing surface;
a seal positionable in said bore and for providing a seal between said valve body and said valve member, said seal having a seal surface engageable with said sealing surface of said valve member when said valve member is in said closed position, said seal having an outer surface engageable with said valve body, said seal defining a second groove in said outer surface, said second groove being substantially co-extensive with at least a portion of said first groove to define a groove pocket when said seal is positioned in said bore; and
a retainer having a portion positionable in said first groove and an other portion positionable in said second groove to prevent movement of said seal relative to said valve body along said bore axis, said retainer being positioned in said groove pocket through said opening.

20. A valve comprising:
a valve body having an outer surface and defining a bore having a bore axis and a circumference, said valve body having an upstream end and a downstream end, said valve body defining a groove extending about a portion of said circumference proximate said upstream end;
a valve member supportable in said bore for pivotable movement about a pivot axis substantially transverse to said bore axis, said valve member being movable between a closed position, in which flow through said valve is substantially prevented, and an open position, said valve member having a circumferential sealing surface;
a seal positionable in said bore and for providing a seal between said valve body and said valve member, said seal having a seal surface engageable with said sealing surface of said valve member when said valve member is in said closed position, said seal having an outer surface engageable with said valve body;and
a retainer having a portion positionable in said groove to prevent movement of said seal relative to said valve body along said bore axis, said retainer being integrally formed with said seal.

21. A method of assembling a valve, the valve including a valve body having an outer surface and defining a bore having a bore axis and a circumference, the valve body also defining a groove extending about a portion of the circumference, a valve member supportable in the bore for pivotable movement about a pivot axis substantially transverse to the bore axis, the valve member being pivotable between a closed position, in which flow through the valve is substantially prevented, and an open position, the valve member having a circumferential sealing surface, a seal assembly positionable in the bore and for providing a seal between the valve body and the valve member, the seal having a seal surface and an outer surface, and a retainer, said method comprising the acts of:
positioning the seal assembly in the bore so that the seal engages the valve body;
supporting the valve member in the bore so that the seal surface of the valve member is engageable with the seal surface of the seal when the valve member is in the closed position; and
positioning the retainer so that a portion of the retainer is positioned in the groove to prevent movement of the seal relative to the valve body along the bore axis.

22. The method as set forth in claim 21 wherein the valve body defines an opening in the outer surface, the opening communicating with the first-mentioned groove, wherein the seal assembly defines a second groove in the outer surface, wherein, in said act of positioning the seal assembly, the seal assembly is positioned with the second groove being substantially co-extensive with at least a portion of the first-mentioned groove to define a groove pocket, wherein, in said act of positioning the retainer, the retainer is positioned so that another portion of the retainer is positioned in the second groove, the retainer being positioned in the groove pocket through the opening.

23. The method as set forth in claim 22 wherein the first-mentioned groove extends substantially about the circumference of the bore, wherein the seal assembly defines a plurality of second grooves, each of the plurality of second grooves being circumferentially spaced apart from others of the plurality of second grooves and being co-extensive with a portion of the first-mentioned groove, the first-mentioned groove and the plurality of second grooves respectively defining a plurality of groove pockets, wherein the retainer assembly includes a plurality of retainers, and wherein the valve body defines a plurality of openings, one of the plurality of openings communicating with one of the plurality of groove pockets, and said method further comprising the act of positioning one of said plurality of retainers in one of said plurality of groove pockets through the communicating one of the plurality of openings.

24. The method as set forth in claim 22 wherein the valve further includes a closing member positionable in the opening, and said method further comprising the act of closing the opening by positioning the closing member in the opening to prevent removal of the retainer member from the groove pocket.

25. The method as set forth in claim 22 wherein the seal assembly includes a seal member providing the seal surface and a support member engageable with the seal member, the support member being engageable with the valve body and defining the second groove, said method further comprising the act of engaging the support member with the seal member to prevent movement of the seal member relative to the support member along the bore axis.

26. The method as set forth in claim 21 wherein the valve is connectable with a pipe in dead-end service, wherein a portion of the seal surface of the seal is engageable with the pipe, said method further comprising the acts of:
engaging the seal surface of the seal with the pipe to provide a seal between the pipe and the valve; and
connecting the valve to the pipe.
